(19) United States
(12) Patent Application Publication
(10) Pub. No.: US 2025/0337318 A1
(43) Pub. Date: Oct. 30, 2025

(54) POWER FACTOR CORRECTION CIRCUIT, CONTROLLER, AND ELECTRONIC DEVICE

(71) Applicant: ROHM CO., LTD., Kyoto (JP)

(72) Inventors: Manae ITO, Kyoto (JP); Satoshi MAEJIMA, Kyoto (JP)

(21) Appl. No.: 19/187,257

(22) Filed: Apr. 23, 2025

(30) Foreign Application Priority Data
Apr. 26, 2024 (JP) 2024-072671

(51) Int. Cl. H02M 1/42; H02M 1/00; H02M 3/335

(52) U.S. Cl. CPC H02M 1/4208; H02M 1/0035; H02M 3/33569

(57) ABSTRACT

A power factor correction circuit including a DC/DC converter includes: at least one selected from the group of first voltage dividing resistors and a first switch connected to an application end of a first voltage with a full-wave rectified waveform, and second voltage dividing resistors and a second switch connected to an application end of an output voltage of the DC/DC converter; and a controller configured to control the power factor correction circuit, wherein an on-off operation of at least one selected from the group of the first switch and the second switch is controlled based on a control signal which is input to the controller from outside to switch between a normal state and a standby state.

### CROSS-REFERENCE TO RELATED APPLICATION

The present invention claims priority under 35 U.S.C. § 119 to Japanese Patent Application No. 2024-072671, filed on Apr. 26, 2024, the entire contents of which are incorporated herein by reference.

### TECHNICAL FIELD

The present disclosure relates to a power factor correction circuit, a controller, and an electronic device.

### BACKGROUND

In the related art, a power factor correction circuit causes a power factor to be close to 1 (i.e., 100%) by matching phases of an A C input voltage and an A C input current.

### BRIEF DESCRIPTION OF DRAWINGS

The accompanying drawings, which are incorporated in and constitute a part of the specification, illustrate embodiments of the present disclosure.

FIG. 1 is a circuit diagram showing a configuration of an electronic device according to an embodiment of the present disclosure.

FIG. 2 is a circuit diagram showing a configuration of a PFC circuit according to an embodiment of the present disclosure.

FIG. 3 is a diagram showing an example of an offset voltage generation circuit.

FIG. 4 is a diagram showing an example of a first arithmetic circuit.

FIG. 5 is a diagram showing an example of a first conversion circuit.

FIG. 6 is a diagram showing an example of a second conversion circuit.

FIG. 7 is a diagram showing an example of a second arithmetic circuit.

FIG. 8 is a diagram showing an example of waveforms of an AC voltage and an input current.

FIG. 9 is a diagram showing a configuration of a controller according to a first embodiment of the present disclosure.

FIG. 10 is a diagram showing a configuration of a controller according to a second embodiment of the present disclosure.

FIG. 11 is a timing chart showing an example of an operation in the second embodiment.

FIG. 12 is a diagram showing a configuration of a controller according to a third embodiment of the present disclosure.

FIG. 13 is a diagram showing a configuration of a controller according to a fourth embodiment of the present disclosure.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

Hereinafter, exemplary embodiments of the present disclosure will be described with reference to the drawings.

### <Electronic Device>

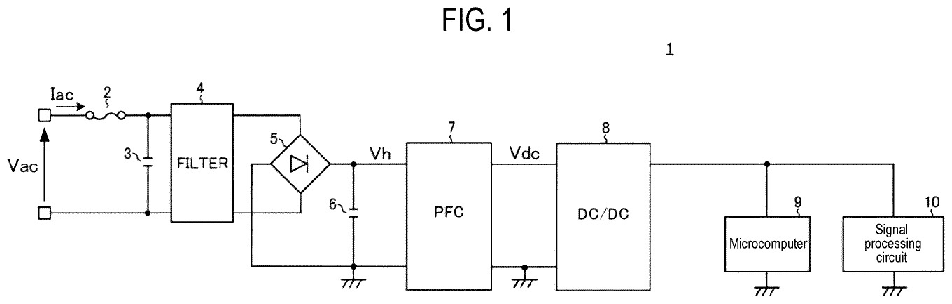

FIG. 1 is a circuit diagram showing a configuration of an electronic device 1 according to an embodiment of the present disclosure. Examples of the electronic device 1 may include home appliances such as a television set, a refrigerator, and an air conditioner or computers, and the like. The electronic device 1 includes a fuse 2, a capacitor 3, a filter 4, a rectifier circuit 5, a capacitor 6, and a power factor correction (PFC) circuit 7. The electronic device 1 further includes a DC/DC converter 8, a microcomputer 9, and a signal processing circuit 10. The electronic device 1 is divided into a primary side and a secondary side, which are insulated from each other, by an isolation transformer (not shown) of the DC/DC converter 8 as a boundary.

The rectifier circuit 5 is, for example, a diode bridge. An AC voltage Vac such as a commercial AC voltage or the like is supplied to the rectifier circuit 5 via the fuse 2, the capacitor 3, and the filter 4. The rectifier circuit 5 full-wave rectifies the A C voltage Vac to generate a first voltage Vh. Therefore, the first voltage Vh has a full-wave rectified waveform.

The first voltage Vh is supplied to the PFC circuit 7 via the capacitor 6. The PFC circuit 7 includes a voltage step-up DC/DC converter (switching regulator) configured to generate an output voltage Vdc from the first voltage Vh. The PFC circuit 7 corrects a power factor by approximately matching phases of the first voltage Vh and the input current lac.

The DC/DC converter 8 receives the output voltage Vdc of the PFC circuit 7, steps the output voltage Vdc down, and supplies the same to each of the microcomputer 9 and the signal processing circuit 10 which are loads.

The microcomputer 9 generally controls the entire electronic device 1. The signal processing circuit 10 is a block configured to perform specific signal processing, and may be, for example, an interface circuit configured to communicate with external devices, an image processing circuit, an audio processing circuit, and the like. Needless to say, in an actual electronic device 1, multiple signal processing circuits 10 are provided according to functions thereof.

The configuration of the electronic device 1 has been described above. As described above, AC/DC conversion is performed by the electronic device including the rectifier circuit 5 configured to perform full-wave rectification of the AC voltage Vac and the PFC circuit 7 configured to step up the first voltage Vh after full-wave rectification to generate the output voltage Vdc. Next, details of the PFC circuit 7 mounted on the electronic device 1 will be described.

### <PFC Circuit>

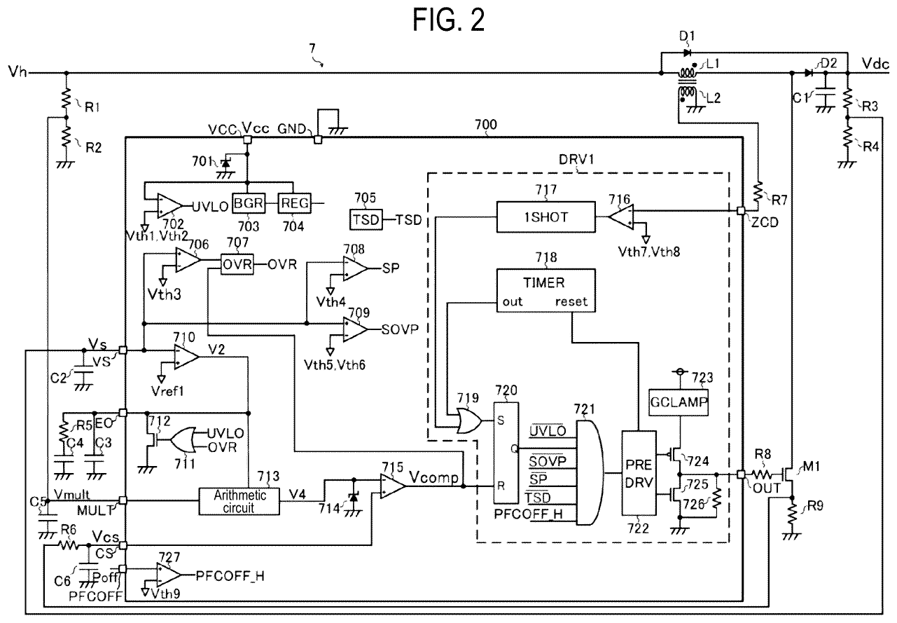

FIG. 2 is a circuit diagram showing a configuration of the PFC circuit 7 according to an embodiment of the present disclosure. As described above, the PFC circuit 7 includes the voltage step-up DC/DC converter (switching regulator). Unlike the present embodiment, the PFC circuit 7 may include a DC/DC converter other than a voltage step-up type.

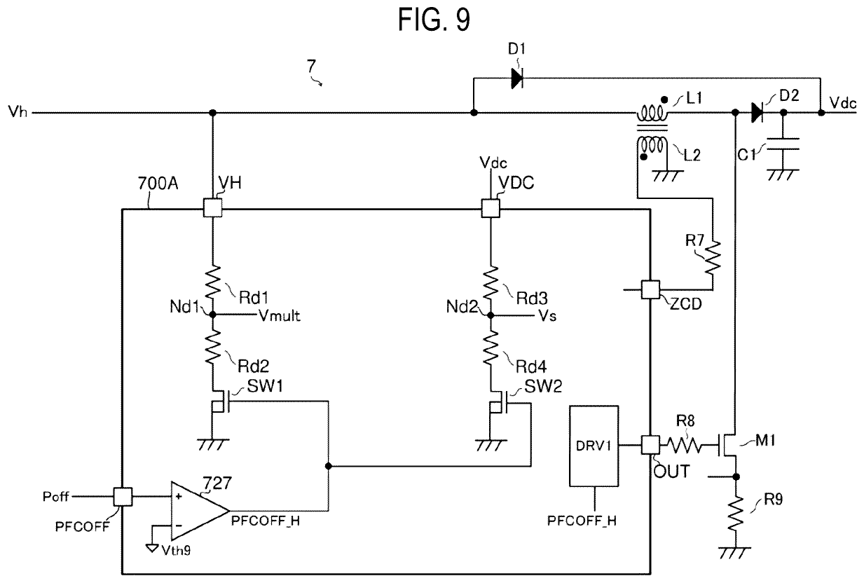

The PFC circuit 7 includes a controller 700, resistors R1 to R9, capacitors C1 to C6, diodes D1 and D2, inductors L1 and L2, and a switching transistor M1. In the present embodiment, the switching transistor M1 is an NMOS transistor (N-channel metal-oxide-semiconductor field-effect transistor (MOSFET)). Although the switching transistor is provided outside a controller in a configuration shown in FIG. 9, the present disclosure is not limited thereto and the switching transistor may be built into the controller.

The controller 700 is a device configured to control the PFC circuit 7, and includes an IC integrating internal configurations shown in FIG. 2. The controller 700 includes a terminal VCC, a terminal GND, a terminal ZCD, a terminal OUT, a terminal CS, a terminal MULT, a terminal EO, and a terminal VS as external terminals for establishing electrical connection with the outside.

The first voltage Vh is applied to one end of the resistor R1. The other end of the resistor R1 is connected to one end of the resistor R2, one end of the capacitor C5, and the terminal MULT. The other end of the resistor R2 and the other end of the capacitor C5 are connected to a ground end (an application end to which a ground potential is applied). According to this configuration, a voltage Vmult, which is a divided voltage obtained from the first voltage Vh divided by the resistors R1 and R2, is supplied to the terminal MULT.

One end of the resistor R1 is connected to one end of the inductor L1 and an anode of the diode D1. The other end of the inductor L1 is connected to an anode of the diode D2 and a drain of the switching transistor M1. Cathodes of the diodes D1 and D2 are connected to one end of the capacitor C1. The other end of the capacitor C1 is connected to the ground end, a gate of the switching transistor M1 is connected to the terminal OUT via the resistor R8, and a source of the switching transistor M1 is connected to the ground end via the resistor R9. According to this configuration, the PFC circuit 7 includes the voltage step-up DC/DC converter (switching regulator). The voltage Vdc, which is an output voltage of the voltage step-up DC/DC converter (switching regulator), is output from one end of the capacitor C1.

The inductor L1 and the inductor L2 are magnetically coupled to each other. One end of the inductor L2 is connected to the terminal ZCD via the resistor R7. The other end of the inductor L2 is connected to the ground end. According to this configuration, the controller 700 can detect zero crossing of a current flowing through the inductor L1 by monitoring a voltage supplied to the terminal ZCD.

The output voltage Vdc is applied to one end of the resistor R3. The other end of the resistor R3 is connected to one end of the resistor R4, one end of the capacitor C2, and the terminal VS. The other end of the resistor R4 and the other end of the capacitor C2 are connected to the ground end. According to this configuration, a detection voltage Vs, which is a divided voltage obtained from an output voltage Vdc divided by the resistors R3 and R4, is supplied to the terminal VS.

One end of the resistor R9 is connected to the source of the switching transistor M1, and the other end of the resistor R9 is connected to the ground end. A voltage proportional to the current flowing through the switching transistor M1 (a drain current of the switching transistor M1) is generated across the resistor R9. An RC circuit (low-pass filter) constituted by the resistor R6 and the capacitor C6 removes a high-frequency component from the voltage (current detection signal) generated across the resistor R9 to generate a detection voltage Vcs, and supplies the detection voltage Vcs to the terminal CS. The detection voltage Vcs is a voltage that corresponds to the current flowing through the switching transistor.

One end of the resistor R5 and one end of the capacitor C3 are connected to the terminal EO. The other end of the resistor R5 is connected to one end of the capacitor C4. The other end of the capacitor C3 and the other end of the capacitor C4 are connected to the ground end. A power supply voltage Vcc is supplied to the terminal VCC, and the terminal GND is connected to the ground end.

### <Controller>

A specific configuration of the controller 700 will be described below.

The controller 700 includes a Zener diode 701, a comparator 702, a bandgap reference voltage circuit 703, a constant voltage circuit 704, and an overheat protection circuit 705. An anode of the Zener diode 701 is connected to the ground end, and a cathode of the Zener diode 701 is connected to the terminal VCC.

The Zener diode 701 clamps the power supply voltage Vcc to a Zener voltage. An inverting input terminal (−) of the comparator 702, the bandgap reference voltage circuit 703, and the constant voltage circuit 704 are connected to the terminal VCC.

The comparator 702 is a hysteresis comparator configured to compare the power supply voltage Vcc with a threshold voltage and outputs a low voltage lockout signal UVLO indicating a comparison result. In a case where the power supply voltage Vcc is equal to or higher than the threshold voltage, the low voltage lockout signal UVLO has a low level (a level indicating a normal state), and in a case where the power supply voltage Vcc is less than the threshold voltage, the low voltage lockout signal UVLO has a high level (a level indicating an abnormal state). The threshold voltage used by the comparator 702 transitions between a first threshold voltage Vth1 (e.g., 8 [V]) and a second threshold voltage Vth2 (e.g., 13 [V]) according to the level of the low voltage lockout signal UVLO.

The bandgap reference voltage circuit 703 generates a reference voltage by using the power supply voltage Vcc and supplies the same to the constant voltage circuit 704.

The constant voltage circuit 704 generates a constant voltage by using the power supply voltage Vcc and the reference voltage and supplies the same to each part of the controller 700.

The overheat protection circuit 705 detects an ambient temperature. In a case where the ambient temperature is equal to or higher than a threshold temperature, the overheat protection circuit 705 outputs an overheat protection signal TSD at a high level (a level indicating an abnormal state), and in a case where the ambient temperature is lower than the threshold temperature, the overheat protection circuit 705 outputs an overheat protection signal TSD at a low level (a level indicating a normal state).

The controller 700 further includes a comparator 706, a startup excessive voltage step-up reduction circuit 707, a comparator 708, and a comparator 709.

The comparator 706 compares the detection voltage Vs with a threshold voltage Vth3 (e.g., 2.25 V) and outputs a comparison result to the startup excessive voltage step-up reduction circuit 707. In a case where the detection voltage Vs is equal to or higher than the threshold voltage Vth3, the output signal of the comparator 706 has a high level (a level indicating an abnormal state), and in a case where the detection voltage Vs is less than the threshold voltage Vth3, the output signal of the comparator 706 has a low level (a level indicating a normal state).

The startup excessive voltage step-up reduction circuit 707 outputs a startup excessive voltage step-up reduction signal OVR. When the detection voltage Vs rises to the threshold voltage Vth3 at the startup, based on the output signal of the comparator 706 and an output voltage Vcomp of a comparator 715 (described later), the startup excessive voltage step-up reduction circuit 707 sets the startup excessive voltage step-up reduction signal OVR to a high level (a level indicating an abnormal state) until a second voltage V2 (described later) drops to a constant voltage Vburst (described later), and sets the startup excessive voltage step-up reduction signal OVR to a low level (a level indicating a normal state) otherwise.

The comparator 708 compares the detection voltage Vs with a threshold voltage Vth4 (e.g., 0.3 V) and outputs a short-circuit protection signal SP, which is a comparison result. In a case where the detection voltage Vs is equal to or higher than the threshold voltage Vth4, the short-circuit protection signal SP has a low level (a level indicating a normal state), and in a case where the detection voltage Vs is less than the threshold voltage Vth4, the short-circuit protection signal SP has a high level (a level indicating an abnormal state).

The comparator 709 is a hysteresis comparator configured to compare the detection voltage Vs with a threshold voltage and outputs a static overvoltage protection signal SOVP indicating a comparison result. In a case where the detection voltage Vs is equal to or higher than the threshold voltage, the static overvoltage protection signal SOVP has a high level (a level indicating an abnormal state), and in a case where the detection voltage Vs is less than the threshold voltage, the static overvoltage protection signal SOVP has a low level (a level indicating a normal state). The threshold voltage used by the comparator 709 transitions between a threshold voltage Vth5 (e.g., 2.6 V) and a threshold voltage Vth6 (e.g., 2.7 V) depending on the level of the static overvoltage protection signal SOVP.

The controller 700 further includes an error amplifier circuit 710, an OR gate 711, an NMOS transistor 712, an arithmetic circuit 713, a Zener diode 714, a comparator 715, and a drive circuit DRV1.

The error amplifier circuit 710 amplifies an error between the detection voltage Vs, which corresponds to the output voltage Vdc of the voltage step-up DC/DC converter (switching regulator) provided in the PFC circuit 7, and the reference voltage Vref1, to generate a second voltage V2. An amplification factor of the error amplifier circuit 710 may be 1. The error amplifier circuit 710 supplies the second voltage V2 to the terminal EO and the arithmetic circuit 713.

The OR gate 711 outputs a logical sum of the low voltage lockout signal UVLO and the startup excessive voltage step-up reduction signal OVR to a gate of the NMOS transistor 712. A drain of the NMOS transistor 712 is connected to the terminal EO, and a source of the NMOS transistor 712 is connected to the ground end. The NMOS transistor 712 is a switch configured to discharge the second voltage applied to the terminal EO. Therefore, when at least one selected from the group of the low voltage lockout signal UVLO and the startup excessive voltage step-up reduction signal OVR is at a high level, the NMOS transistor 712 is turned on and the second voltage V2 drops.

The arithmetic circuit 713 generates a third voltage by multiplying the A C voltage (first voltage) Vmult by the second voltage V2 and generates a fourth voltage V4 by adding an offset voltage Voffset to the third voltage.

The fourth voltage V4 is connected to an inverting input terminal of the comparator 715. A cathode of the Zener diode 714 is connected to the inverting input terminal of the comparator 715, and an anode of the Zener diode 714 is connected to the ground end. The Zener diode 714 clamps the fourth voltage V4 to a Zener voltage.

The comparator 715 compares the detection voltage Vcs corresponding to the current flowing through the switching transistor M1 with the fourth voltage V4, and outputs a voltage Vcomp indicating a comparison result.

The drive circuit DRV1 drives the switching transistor M1 to be turned on and off, and turns off the switching transistor M1 each time the detection voltage Vcs becomes higher than the fourth voltage V4 according to the voltage Vcomp which is the output of the comparator 715. The expression “turn off” refers to switching from an on state to an off state. That is, the drive circuit DRV1 turns off the switching transistor M1 based on the voltage Vcomp which is the output of the comparator 715. The configuration of the drive circuit DRV1 is not particularly limited and may be any known technique.

FIG. 2 shows an example of the drive circuit DRV1. The drive circuit DRV1 includes a comparator 716, a one-shot circuit 717, a timer 718, an OR gate 719, an RS flip-flop 720, an AND gate 721, a pre-driver 722, a gate clamp circuit 723, a PMOS transistor (P-channel MOSFET) 724, an NMOS transistor 725, and a resistor 726.

The comparator 716 is a hysteresis comparator configured to compare the voltage applied to the terminal ZCD with a threshold voltage and outputs the comparison result to the one-shot circuit 717. In a case where the voltage applied to the terminal ZCD is equal to or higher than the threshold voltage, the output signal of the comparator 716 has a low level, and in a case where the voltage applied to the terminal ZCD is lower than the threshold voltage, the output signal of the comparator 716 has a high level. The threshold voltage used by the comparator 716 transitions between a threshold voltage Vth7 (e.g., 0.67 V) and a threshold voltage Vth8 (e.g., 0.9 V) depending on the level of the output signal of the comparator 716.

When the output signal of the comparator 716 has a high level, the one-shot circuit 717 supplies a one-shot pulse to a first input terminal of the OR gate 719.

When the timer 718 measures a certain period of time, it supplies a high-level signal to a second input terminal of the OR gate 719. The measurement by the timer 718 is reset each time the pre-driver 722 receives a high-level signal from the AND gate 721.

The OR gate 719 supplies a logical sum of the output signals of the one-shot circuit 717 and the timer 718 to a set terminal(S) of the RS flip-flop 720. A voltage Vcomp which is the output of the comparator 715 is supplied to a reset terminal (R) of the RS flip-flop 720. The output (Q) of the RS flip-flop 720 transitions to a high level at each positive edge of the voltage applied to the set terminal(S) and transitions to a low level at each positive edge of the voltage applied to the reset terminal (R).

The AND gate 721 supplies the pre-driver 722 with a logical product of the inverted signal of the low voltage lockout signal UVLO, the output signal of the RS flip-flop 720, the inverted signal of the static overvoltage protection signal SOVP, the inverted signal of the short-circuit protection signal SP, the inverted signal of the overheat protection signal TSD, and the PFC off signal PFCOFF_H described later.

The pre-driver 722 drives the PMOS transistor 724 and the NMOS transistor 725 to be complementarily turned on and off, based on the output of the AND gate 721. Specifically, when the output of the AND gate 721 is at a high level, the pre-driver 722 turns on the PMOS transistor 724 and turns off the NMOS transistor 725, thereby setting the voltage of the terminal OUT to a high level and turning on the switching transistor M1. On the other hand, when the output of the AND gate 721 is at a low level, the pre-driver 722 turns off the PMOS transistor 724 and turns on the NMOS transistor 725, thereby setting the voltage of the terminal OUT to a low level and turning off the switching transistor M1.

A source of the PMOS transistor 724 is connected to the gate clamp circuit 723, and a drain of the PMOS transistor 724 is connected to a drain of the NMOS transistor 725, the terminal OUT, and one end of the resistor 726. A source of the NMOS transistor 725 is connected to the ground end and the other end of the resistor 726. The gate clamp circuit 723 generates a high-level voltage to be applied to the terminal OUT from the power supply voltage Vcc. The gate clamp circuit 723 clamps the high-level voltage applied to the terminal OUT to a constant voltage, such that the high-level voltage applied to the terminal OUT does not exceed a gate-source breakdown voltage of the switching transistor M1 when the power supply voltage Vcc rises.

The controller 700 includes a comparator 727 and a terminal PFCOFF as an external terminal. A non-inverting input terminal of the comparator 727 is connected to the terminal PFCOFF. The comparator 727 compares a control signal Poff input to the terminal PFCOFF with a threshold voltage Vth9, and outputs a PFC off signal PFCOFF_H. The PFC off signal PFCOFF_H is input to the AND gate 721. As a result, when the control signal Poff is at a low level, the PFC off signal PFCOFF_H has a low level, and when the control signal Poff is at a high level, the PFC off signal PFCOFF_H has a high level. When the control signal Poff is at a low level, the PFC circuit 7 (controller 700) is in a standby state.

### <Arithmetic Circuit>

The configuration of the PFC circuit 7 has been described above. Next, an internal configuration of the arithmetic circuit 713 will be described. First, a specific example of a configuration of an offset voltage generation circuit 713A provided in the arithmetic circuit 713 will be described.

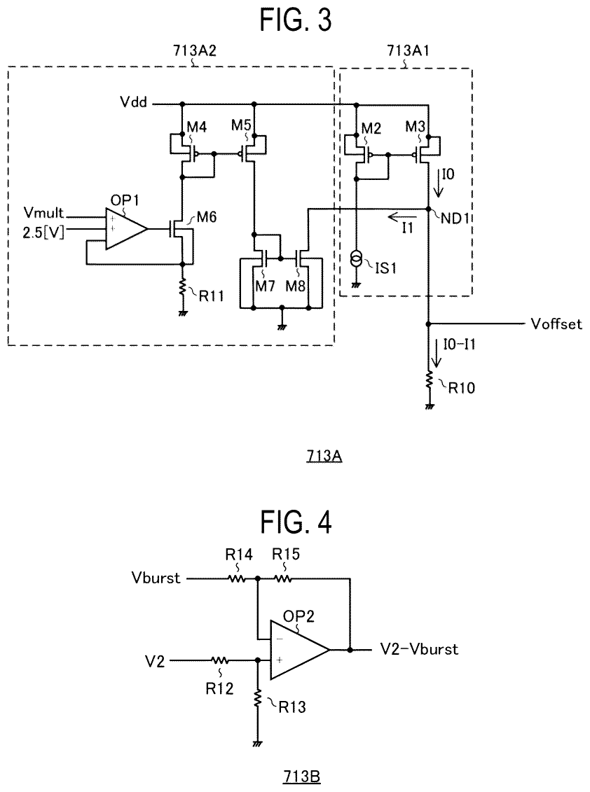

FIG. 3 shows an example of the offset voltage generation circuit 713A. The offset voltage generation circuit 713A includes a constant current generation circuit 713A1, a first current generation circuit 713A2, and a resistor R10.

The constant current generation circuit 713A1 includes a current mirror circuit constituted by PMOS transistors M2 and M3, and a current source IS1. The constant voltage Vdd output from the constant voltage circuit 704 is applied to a source and a back gate of the PMOS transistor M2 and a source and a back gate of the PMOS transistor M3. A gate and a drain of the PMOS transistor M2 and a gate of the PMOS transistor M3 are connected to one end of the current source IS1. The other end of the current source IS1 is connected to the ground end. A drain of the PMOS transistor M3 and one end of the resistor R10 are connected to a node ND1. The other end of the resistor R10 is connected to the ground end. The constant current generation circuit 713A1 generates a constant current I0 and supplies the constant current I0 to the node ND1. A value of the constant current I0 is not particularly limited. For example, in a case where the value of the constant current output by the current source IS1 is 1 μA and a current mirror ratio is 6:1, the value of the constant current I0 is 167 ηA.

The first current generation circuit 713A2 includes an operational amplifier OP1, a sweep-out type current mirror circuit constituted by PMOS transistors M4 and M5, an NMOS transistor M6, a resistor R11, and a pull-out type current mirror circuit constituted by NMOS transistors M7 and M8. The constant voltage Vdd output from the constant voltage circuit 704 is applied to a source and a back gate of the PMOS transistor M4 and a source and a back gate of the PMOS transistor M5. A gate and a drain of the PMOS transistor M4 and a gate of the PMOS transistor M5 are connected to a drain of the NMOS transistor M6.

A source and a back gate of the NMOS transistor M6 are connected to one end of the resistor R11 and an inverting input terminal of the operational amplifier OP1. The other end of the resistor R11 is connected to the ground end. A voltage Vmult is supplied to a first non-inverting input terminal of the operational amplifier OP1, and a constant voltage of, for example, 2.5 V is supplied to a second non-inverting input terminal of the operational amplifier OP1. An output terminal of the operational amplifier OP1 is connected to a gate of the NMOS transistor M6. The operational amplifier OP1 outputs a signal obtained by amplifying a difference between a voltage obtained by adding the voltage Vmult and a constant voltage of, for example, 2.5 V, and a voltage supplied to the inverting input terminal.

A drain of the PMOS transistor M5 is connected to a drain and a gate of the NMOS transistor M7 and a gate of the NMOS transistor M8. A source and a back gate of the NMOS transistor M7 and a source and a back gate of the NMOS transistor M8 are connected to the ground end. A drain of the NMOS transistor M8 is connected to the node ND1. The first current generation circuit 713A2 generates a first current I1 and draws the first current I1 from the node ND1. The first current I1 varies depending on a voltage (AC voltage) Vmult. Specifically, as the voltage Vmult becomes higher, the first current I1 becomes larger. In the example shown in FIG. 3, as the voltage Vmult becomes higher, the first current I1 becomes linearly larger.

A current resulting from subtracting the first current I1 from the constant current I0, i.e., a differential current (I0−I1), flows from the node ND1 to the resistor R10. A product of the differential current (I0−I1) and a resistance value of the resistor R10 is an offset voltage Voffset. Therefore, the offset voltage Voffset varies depending on the voltage Vmult. Specifically, the offset voltage Voffset becomes smaller as the voltage Vmult becomes higher. In the example shown in FIG. 3, the offset voltage Voffset becomes linearly smaller as the voltage Vmult becomes higher.

A range of the offset voltage Voffset is not particularly limited. In the example shown in FIG. 3, for example, in a case where the value of the constant current I0 is 167 nA as described above, a current mirror ratio of the sweep-out type current mirror circuit in the first current generation circuit 713A2 is 10:1, a resistance value of the resistor R11 which is a current source connected to the sweep-out type current mirror circuit is 2 MΩ, a pull-out type current mirror ratio in the first current generation circuit 713A2 is 1:1, and the resistance value of the resistor R10 is 161.2 kΩ, the offset voltage Voffset varies in a range of 6.9 mV to 26.8 mV.

In a case where a design value of a minimum value of the offset voltage Voffset is set to, for example, 6.9 mV as in the above-described example, an actual minimum value of the offset voltage Voffset due to variations in a circuit constant can be made equal to or greater than zero.

In a case where the minimum value of the offset voltage Voffset becomes smaller than zero, the offset voltage generation circuit 713A does not operate normally in the example shown in FIG. 3. Therefore, it is desirable that the minimum value of the offset voltage Voffset is equal to or greater than zero. Since it is conceivable to adopt a circuit configuration so that no malfunction occurs when the minimum value of the offset voltage Voffset becomes smaller than zero, the minimum value of the offset voltage Voffset may be made smaller than zero.

In addition, a trimming element configured to adjust the circuit constant may be provided in the offset voltage generation circuit 713A to suppress variations in the circuit constant and to set the design value of the minimum value of the offset voltage Voffset to zero or close to zero. An example of the trimming element may be at least one fuse provided in a parallel circuit of multiple resistors to adjust a resistance value of a resistor which is a current source connected to the sweep-out type current mirror circuit in the first current generation circuit 713A2. The fuse may be cut by laser trimming, for example.

The configuration of the offset voltage generation circuit 713A has been described above. Next, specific configuration examples of circuits other than the offset voltage generation circuit 713A in the arithmetic circuit 713 will be described. In addition to the offset voltage generation circuit 713A, the arithmetic circuit 713 includes a first arithmetic circuit 713B, a first conversion circuit 713C, a second conversion circuit 713D, and a second arithmetic circuit 713E.

FIG. 4 shows an example of the first arithmetic circuit 713B. The first arithmetic circuit 713B includes resistors R12 to R15 and an operational amplifier OP2. A second voltage V2 is applied to one end of the resistor R12. The other end of the resistor R12 and one end of the resistor R13 are connected to the non-inverting input terminal of the operational amplifier OP2. The other end of the resistor R13 is connected to the ground end. A constant voltage Vburst is applied to one end of the resistor R14. The other end of the resistor R14 and one end of the resistor R15 are connected to the inverting input terminal of the operational amplifier OP2. The other end of the resistor R15 is connected to the output terminal of the operational amplifier OP2. The first arithmetic circuit 713B outputs a voltage (V2−Vburst) obtained by subtracting the constant voltage Vburst from the second voltage V2.

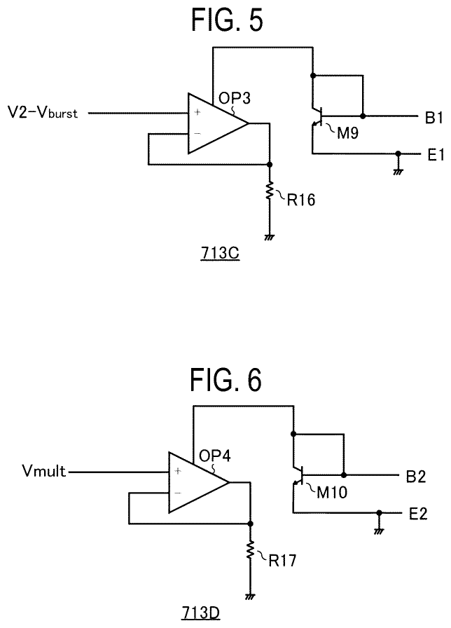

FIG. 5 shows an example of the first conversion circuit 713C. The first conversion circuit 713C includes an operational amplifier OP3, a resistor R16, and an NPN bipolar transistor M9. The voltage (V2−Vburst) is applied to the non-inverting input terminal of the operational amplifier OP3. One end of the resistor R16 is connected to the inverting input terminal and the output terminal of the operational amplifier OP3. The other end of the resistor R16 is connected to the ground end. A collector and a base of the NPN bipolar transistor M9 are connected to a power supply terminal of the operational amplifier OP3. An emitter of the NPN bipolar transistor M9 is connected to the ground end. The first conversion circuit 713C converts the voltage (V2−Vburst) into a current (I2−Iburst) and outputs the current (I2−Iburst) as a base current of the NPN bipolar transistor M9.

FIG. 6 shows an example of the second conversion circuit 713D. The second conversion circuit 713D includes an operational amplifier OP4, a resistor R17, and an NPN bipolar transistor M10. The voltage Vmult is applied to the non-inverting input terminal of the operational amplifier OP4. One end of the resistor R17 is connected to the inverting input terminal and the output terminal of the operational amplifier OP4. The other end of the resistor R17 is connected to the ground end. A collector and a base of the NPN bipolar transistor M10 are connected to a power supply terminal of the operational amplifier OP4. An emitter of the NPN bipolar transistor M10 is connected to the ground end. The second conversion circuit 713D converts the voltage Vmult into a current Imult and outputs the current Imult as a base current of the NPN bipolar transistor M10.

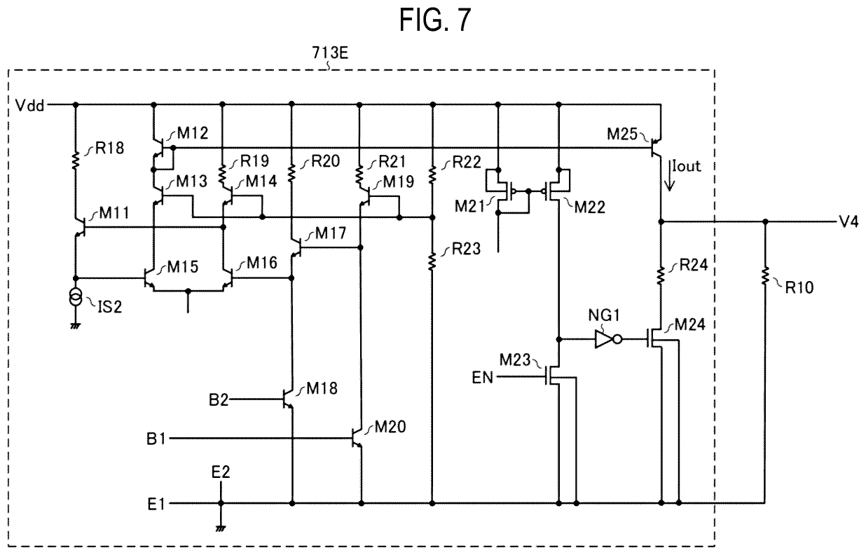

FIG. 7 shows an example of the second arithmetic circuit 713E. The second arithmetic circuit 713E includes resistors R18 to R24, a current source IS2, NPN bipolar transistors M11 to M20, PMOS transistors M21 and M22, NMOS transistors M23 and M24, a PNP bipolar transistor M25, and a NOT gate NG1.

The constant voltage Vdd output from the constant voltage circuit 704 is applied to one end of each of the resistors R18 to R22, a collector of the NPN bipolar transistor M12, a source and a back gate of the PMOS transistor M21, a source and a back gate of the PMOS transistor M22, and an emitter of the PNP bipolar transistor M25. The other end of the resistor R18 is connected to a collector of the NPN bipolar transistor M11. An emitter of the NPN bipolar transistor M11 is connected to one end of the current source IS2 and a base of the NPN bipolar transistor M15. The other end of the current source IS2 is connected to the ground end.

A base and an emitter of the NPN bipolar transistor M12 are connected to a base of the PNP bipolar transistor M25 and a collector of the NPN bipolar transistor M13. An emitter of the NPN bipolar transistor M13 is connected to a collector of the NPN bipolar transistor M15. An emitter of the NPN bipolar transistor M15 is connected to an emitter of the NPN bipolar transistor M16. The other end of the resistor R19 is connected to a collector of the NPN bipolar transistor M14. An emitter of the NPN bipolar transistor M14 is connected to a base of the NPN bipolar transistor M11 and a collector of the NPN bipolar transistor M16.

The other end of the resistor R20 is connected to a collector of the NPN bipolar transistor M17. An emitter of the NPN bipolar transistor M17 is connected to a base of the NPN bipolar transistor M16 and a collector of the NPN bipolar transistor M18. An emitter of the NPN bipolar transistor M18 is connected to the ground end. A base of the NPN bipolar transistor M18 is connected to the base and collector of the NPN bipolar transistor M10 in the second conversion circuit 713D. The NPN bipolar transistors M10 and M18 form a current mirror circuit.

The other end of the resistor R21 is connected to a collector of the NPN bipolar transistor M19. An emitter of the NPN bipolar transistor M19 is connected to a base of the NPN bipolar transistor M17 and a collector of the NPN bipolar transistor M20. An emitter of the NPN bipolar transistor M20 is connected to the ground end. A base of the NPN bipolar transistor M20 is connected to the base and the collector of the NPN bipolar transistor M9 in the first conversion circuit 713C. The NPN bipolar transistors M9 and M20 constitute a current mirror circuit.

The other end of the resistor R22 is connected to one end of the resistor R23, a base of the NPN bipolar transistor M13, a base of the NPN bipolar transistor M14, and a base of the NPN bipolar transistor M19. The other end of the resistor R23 is connected to the ground end.

A gate and a drain of the PMOS transistor M21 are connected to a gate of the PMOS transistor M22. The PMOS transistors M21 and M22 constitute a current mirror circuit. A drain of the PMOS transistor M22 is connected to a drain of the NMOS transistor M23 and an input terminal of the NOT gate. An enable signal EN is supplied to a gate of the NMOS transistor M23. A source and a back gate of the NMOS transistor M23 are connected to the ground end. An output terminal of the NOT gate is connected to a gate of the NMOS transistor M24. A source and a back gate of the NMOS transistor M24 are connected to the ground end. A drain of the NMOS transistor M24 is connected to one end of the resistor R24. The other end of the resistor R24 is connected to a collector of the PNP bipolar transistor M25 and one end of the resistor R10. The other end of the resistor R10 is connected to the ground end.

The second arithmetic circuit 713E multiplies the current (I2−Iburst) by the current Imult, and outputs an output current Iout, which is a result of the multiplication, to the resistor R10. The resistor R10 converts the output current Iout into a voltage (K×Vmult (V2−Vburst)). The constant K is determined by a ratio between a resistance value of the resistor R16 and the resistance value of the resistor R10 in the first conversion circuit 713C, and a ratio between a resistance value of the resistor R17 and the resistance value of the resistor R10 in the second conversion circuit 713D. The current I3 output by the current source IS2 in the second arithmetic circuit 713E is a current proportional to a peak value (maximum value) of the voltage Vmult. A state of the second arithmetic circuit 713E may be switched between an enabled state and a disabled state by the enable signal EN.

The resistor R10 shown in FIG. 7 is the same as the resistor R10 provided in the offset voltage generation circuit 713A shown in FIG. 3. Therefore, the offset voltage Voffset is also applied to the resistor R10. Thus, the fourth voltage V4 generated in the resistor R10 as the voltage across the resistor R10 is expressed by the formula below.

V4=K×Vmult(V2−Vburst)+Voffset

Here, in order to explain an effect of the PFC circuit 7, a circuit in which the offset voltage generation circuit 713A is removed from the PFC circuit 7 will be compared with the PFC circuit 7.

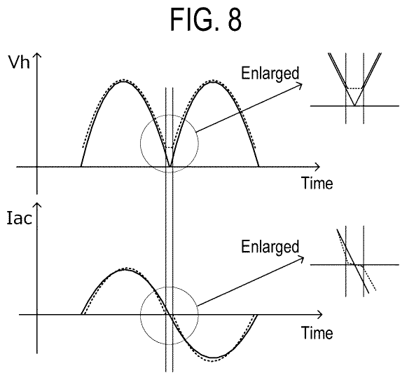

In the circuit in which the offset voltage generation circuit 713A is removed from the PFC circuit 7, an on-time of the switching transistor M1 when the first voltage Vh is near 0 V is shortened by an operation of the drive circuit DRV1. Therefore, when the first voltage Vh is near 0 V, the capacitor 6 provided on an output side of the rectifier circuit 5 may not be sufficiently discharged. As a result, the current output from the rectifier circuit 5 is temporarily stopped, causing distortion in the input current lac (see dotted lines in FIG. 8).

On the other hand, in the PFC circuit 7, when the first voltage Vh is near 0 V, the offset voltage Voffset increases and the fourth voltage V4 also increases, such that the on-time of the switching transistor M1 is lengthened by the operation of the drive circuit DRV1. Therefore, when the first voltage Vh is near 0 V, the capacitor 6 provided on the output side of the rectifier circuit 5 may be sufficiently discharged. As a result, a current is smoothly output from the rectifier circuit 5 and distortion of the input current lac is suppressed (see solid lines in FIG. 8). In other words, the controller 700 can suppress a total harmonic distortion (THD) of the PFC circuit 7.

Since it is not necessary to increase the offset voltage Voffset when the first voltage Vh is not near 0 V, it is preferable that the offset voltage Voffset is variable as in the above-described embodiment. However, the offset voltage Voffset may be fixed by permitting addition of unnecessary offset voltage Voffset when the first voltage Vh is not near 0 V.

### <Problem in PFC Circuit>

However, the above-described PFC circuit 7 (FIG. 2) has the following problem. By setting the control signal Poff to a low level, the PFC off signal PFCOFF_H becomes a low level, the voltage at the terminal OUT has a low level by the pre-driver 722, and the switching transistor M1 is turned off. Thus, the PFC circuit 7 is put into a standby state, thereby reducing power consumption. However, even in the standby state, power consumption occurs in the resistors R1 and R2 for generating the voltage Vmult and in the resistors R3 and F4 for generating the detection voltage Vs. Therefore, it is necessary to further reduce the standby power.

### First Embodiment

To solve the above problem, the embodiment of the present disclosure described below is implemented. FIG. 9 is a diagram showing a configuration of a controller 700A according to a first embodiment of the present disclosure. For the sake of convenience, FIG. 9 shows parts relating to differences from the configuration shown in FIG. 2 described above and does not show the same configurations of the controller 700A as those of the controller 700. The same also applies to drawings relating to the controllers according to other embodiments described below.

As shown in FIG. 9, the controller 700A includes, in addition to the comparator 727 and the drive circuit DRV1, voltage dividing resistors Rd1 and Rd2, voltage dividing resistors Rd3 and Rd4, and switches SW1 and SW2. That is, the controller 700A is provided with the voltage dividing resistors Rd1 and Rd2, the voltage dividing resistors Rd3 and Rd4, and the switches SW1 and SW2 therein. The controller 700A further includes a terminal VH and a terminal VDC as external terminals.

The terminal VH is connected to an application end of the first voltage Vh. One end of the voltage dividing resistor Rd1 is connected to the terminal VH. The other end of the voltage dividing resistor Rd1 is connected to one end of the voltage dividing resistor Rd2. The switch SW1 is an NMOS transistor. The other end of the voltage dividing resistor Rd2 is connected to a drain of the switch SW1. A source of the switch SW1 is connected to the ground end. An output end of the comparator 727 is connected to a gate of the switch SW1. That is, the PFC off signal PFCOFF_H output from the comparator 727 is applied to the gate of the switch SW1.

The terminal VDC is connected to an application end of the output voltage Vdc. One end of the voltage dividing resistor Rd3 is connected to the terminal VDC. The other end of the voltage dividing resistor Rd3 is connected to one end of the voltage dividing resistor Rd4. The switch SW2 is an NMOS transistor. The other end of the voltage dividing resistor Rd4 is connected to a drain of the switch SW2. A source of the switch SW2 is connected to the ground end. The output end of the comparator 727 is connected to a gate of the switch SW2. That is, the PFC off signal PFCOFF_H output from the comparator 727 is applied to the gate of the switch SW2.

According to the above configuration, when the control signal Poff is at a high level, the PFC off signal PFCOFF_H is at a high level, and the drive circuit DRV1 drives the switching transistor M1 to be turned on and off. In such a normal state, since the PFC off signal PFCOFF_H is at a high level, the switches SW1 and SW2 are both in an on state. Therefore, the first voltage Vh applied to the terminal VH is divided by the voltage dividing resistors Rd1 and Rd2, and a voltage Vmult is generated at the node Nd1 to which the voltage dividing resistors Rd1 and Rd2 are connected. The voltage Vmult is supplied to the arithmetic circuit 713 (not shown in FIG. 9) of the controller 700A in the same manner as in FIG. 2 described above. In addition, the output voltage Vdc applied to the terminal VDC is divided by the voltage dividing resistors Rd3 and Rd4, and a detection voltage Vs is generated at the node Nd2 to which the voltage dividing resistors Rd3 and Rd4 are connected. The detection voltage Vs is supplied to the error amplifier circuit 710 (not shown in FIG. 9) and the like of the controller 700A in the same manner as in FIG. 2 described above.

On the other hand, when the control signal Poff is at a low level, the PFC off signal PFCOFF_H has a low level, and the drive circuit DRV1 turns off the switching transistor M1. In such a standby state, since the PFC off signal PFCOFF_H is at a low level, the switches SW1 and SW2 are both turned off. Therefore, no current flows through the voltage dividing resistors Rd1 and Rd2 and the voltage dividing resistors Rd3 and Rd4, and power consumption in the standby state can be reduced. Since high voltages Vh and Vdc are applied to the terminals VH and VDC, respectively, the terminals VH and VDC need to be high-voltage terminals.

### Second Embodiment

In the first embodiment, the power consumption in the standby state can be reduced. However, in the standby state, the switches SW1 and SW2 are in an off state, the voltage Vmult is a first voltage VH, and the detection voltage Vs is an output voltage Vdc, which causes a problem that a high voltage is applied to an internal circuit (such as an arithmetic circuit or an error amplifier circuit) to which the voltage Vmult or the detection voltage Vs is applied.

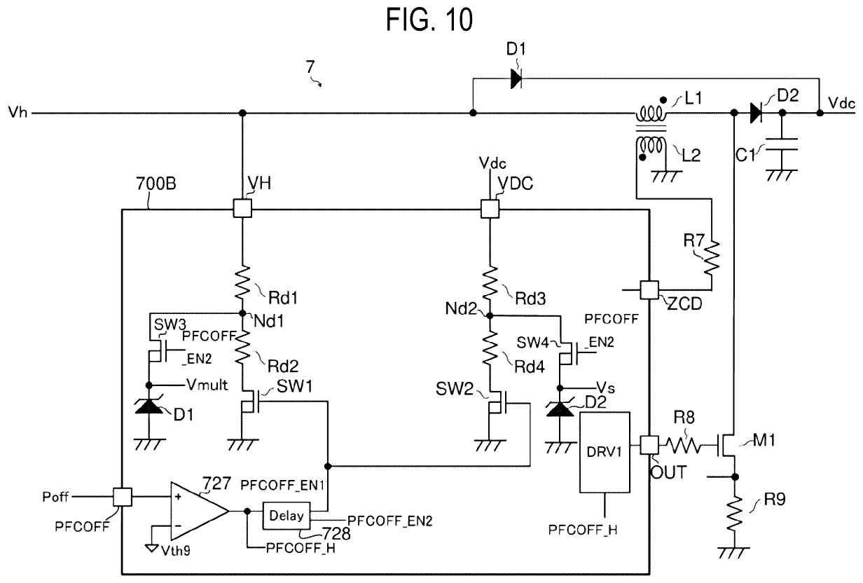

Considering the above problem, a second embodiment is implemented. FIG. 10 is a diagram showing a configuration of a controller 700B according to the second embodiment of the present disclosure. The controller 700B differs from the controller of the first embodiment in that it includes switches SW3 and SW4, diodes D1 and D2, and a delay circuit 728.

The switch SW3 is an NMOS transistor. A drain of the switch SW3 is connected to the node Nd1. A source of the switch SW3 is connected to the cathode of the diode D1. An anode of the diode D1 is connected to the ground end.

The switch SW4 is an NMOS transistor. A drain of the switch SW4 is connected to the node Nd2. A source of the switch SW4 is connected to the cathode of the diode D2. The anode of the diode D2 is connected to the ground end.

The delay circuit 728 generates PFC off enable signals PFCOFF_EN1 and PFCOFF_EN2 by delaying the PFC off signal PFCOFF_H output from the comparator 727. The PFC off enable signal PFCOFF_EN1 is applied to the gates of the switches SW1 and SW2. The PFC off enable signal PFCOFF_EN2 is applied to the gates of the switches SW3 and SW4.

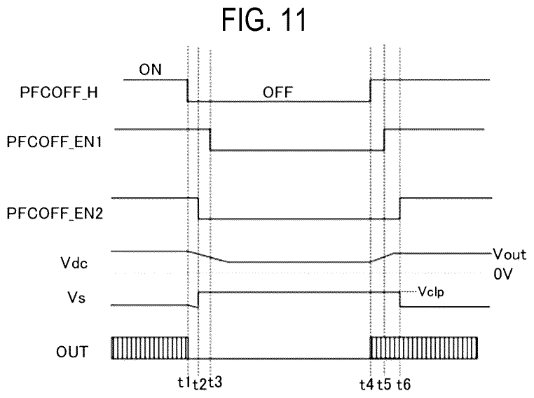

An operation of a configuration of the second embodiment will be described with reference to a timing chart shown in FIG. 11. FIG. 11 shows, sequentially from the top, examples of waveforms of the PFC off signal PFCOFF_H, the PFC off enable signal PFCOFF_EN1, the PFC off enable signal PFCOFF_EN2, the output voltage Vdc, the detection voltage Vs, and the voltage at the terminal OUT.

In a state before timing t1 in FIG. 11, the PFC off signal PFCOFF_H is at a high level indicating a normal state (i.e., the control signal Poff is at a high level), and the PFC off enable signals PFCOFF_EN1 and PFCOFF_EN2 are both at a high level. Therefore, the switches SW1 to SW4 are all in an on state, the voltage Vmult has a value obtained by dividing the first voltage Vh by the voltage dividing resistors Rd1 and Rd2, and the detection voltage Vs has a value obtained by dividing the output voltage Vdc by the voltage dividing resistors Rd3 and Rd4. At this time, a level of the voltage of the terminal OUT is repeatedly switched between a high level and a low level by the drive circuit DRV1, the switching transistor M1 is switched, and the output voltage Vdc is controlled to a target value V out (e.g., 400 V).

Then, at timing t1, the control signal Poff has a low level, causing the PFC off signal PFCOFF_H to have a low level indicating a standby state. Then, the drive circuit DRV1 sets the voltage at the terminal OUT to a low level, turning off the switching transistor M1 and stopping the switching. As a result, the output voltage Vdc starts to decrease. Accordingly, the detection voltage Vs also starts to decrease.

Thereafter, at timing t2, the PFC off enable signal PFCOFF_EN2 falls to a low level ahead of the PFC off enable signal PFCOFF_EN1. That is, a delay amount of the PFC off enable signal PFCOFF_EN2 with respect to a falling edge of the PFC off signal PFCOFF_H is smaller than that of the PFC off enable signal PFCOFF_EN1. Therefore, the switches SW3 and SW4 are turned off ahead of the switches SW1 and SW2. As a result, the voltage Vmult and the detection voltage Vs are in an undefined state, and are clamped by the diodes D1 and D2, respectively, which makes it possible to prevent the voltage Vmult and the detection voltage Vs from becoming high voltages. FIG. 11 shows a state in which the detection voltage Vs is clamped to a clamp voltage Vclp by the diode D2.

Thereafter, at timing t3, the PFC off enable signal PFCOFF_EN1 has a low level, such that the switches SW1 and SW2 are turned off. This makes it possible to suppress the power consumption by the voltage dividing resistors Rd1 and Rd2 or Rd3 and Rd4 in the standby state. In this way, when transitioning to the standby state, it is possible to suppress the standby power consumption while suppressing the application of a high voltage by the voltage Vmult or the detection voltage Vs to the internal circuit.

At timing t4, the control signal Poff has a high level, causing the PFC off signal PFCOFF_H to have a high level which indicates a normal state. Thus, the switching of the switching transistor M1 by the drive circuit DRV1 is resumed, and the output voltage Vdc rises.

Then, at timing t5, the PFC off enable signal PFCOFF_EN1 rises to a high level ahead of the PFC off enable signal PFCOFF_EN2. That is, a delay amount of the PFC off enable signal PFCOFF_EN1 with respect to a rising edge of the PFC off signal PFCOFF_H is smaller than that of the PFC off enable signal PFCOFF_EN2. As a result, the switches SW1 and SW2 are turned on ahead of the switches SW3 and SW4, a voltage obtained by dividing the first voltage Vh is generated at the node Nd1, and a voltage obtained by dividing the output voltage Vdc is generated at the node Nd2.

Thereafter, at timing t6, the PFC off enable signal PFCOFF_EN2 rises to a high level, and the switches SW3 and SW4 are turned on. As a result, the voltage Vmult has a value obtained by dividing the first voltage Vh, and the detection voltage Vs has a value obtained by dividing the output voltage Vdc. In this way, even when transitioning to the normal state, it is possible to prevent a high voltage from being applied to the internal circuit by the voltage Vmult or the detection voltage Vs.

### Third Embodiment

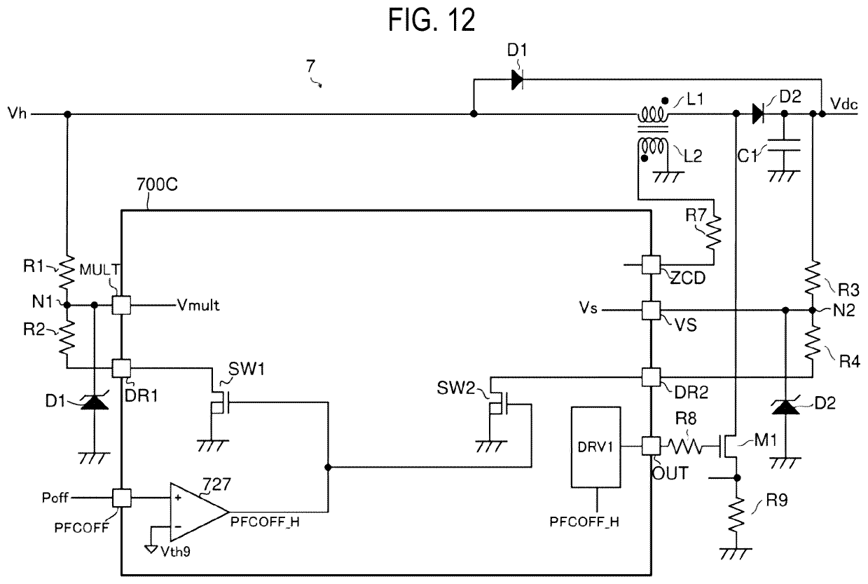

FIG. 12 is a diagram showing a configuration of a controller 700C according to a third embodiment of the present disclosure. In the present embodiment, resistors R1 and R2 and resistors R3 and R4 are connected externally to the controller 700C. The controller 700C includes built-in switches SW1 and SW2, and terminals MULT, VS, DR1, and DR2 as external terminals. In other words, the resistors R1 to R4 are provided in the PFC circuit 7 including the controller 700C. Further, in the PFC circuit 7, the diodes D1 and D2 are provided outside the controller 700C.

One end of the resistor R1 is connected to an application end of the first voltage Vh. The other end of the resistor R1 is connected to one end of the resistor R2. The other end of the resistor R2 is connected to the terminal DR1. The terminal DR1 is connected to the drain of the switch SW1. A source of the switch SW1 is connected to the ground end. A node N1 to which the resistors R1 and R2 are connected is connected to the terminal MULT. The terminal MULT is connected to a cathode of the diode D1. An anode of the diode D1 is connected to the ground end.

An application end of an output voltage Vdc is connected to one end of the resistor R3. The other end of the resistor R3 is connected to one end of the resistor R4. The other end of the resistor R4 is connected to the terminal DR2. The terminal DR2 is connected to a drain of the switch SW2. A source of the switch SW2 is connected to the ground end. A node N2 to which the resistors R3 and R4 are connected is connected to the terminal VS. The terminal VS is connected to a cathode of the diode D2. An anode of the diode D2 is connected to the ground end.

In the above configuration, the PFC off signal PFCOFF_H is applied to gates of the switches SW1 and SW2. When the control signal Poff is at a high level indicating a normal state and the PFC off signal PFCOFF_H is at a high level, the switches SW1 and SW2 are in an on state. As a result, a voltage Vmult obtained by dividing the first voltage Vh by the resistors R1 and R2 is generated at the terminal MULT, and a detection voltage Vs obtained by dividing the output voltage Vdc by the resistors R3 and R4 is generated at the terminal VS.

On the other hand, when the control signal Poff is at a low level indicating a standby state and the PFC off signal PFCOFF_H is at a low level, the switches SW1 and SW2 are in an off state. This makes it possible to reduce the power consumption by the resistors R1 and R2 or R3 and R4 in the standby state. At this time, the voltage of the terminal MULT and the voltage of the terminal VS are clamped by the diodes D1 and D2, respectively, such that it is possible to prevent a high voltage from being applied to the internal circuit by the voltage Vmult or the detection voltage Vs.

### Fourth Embodiment

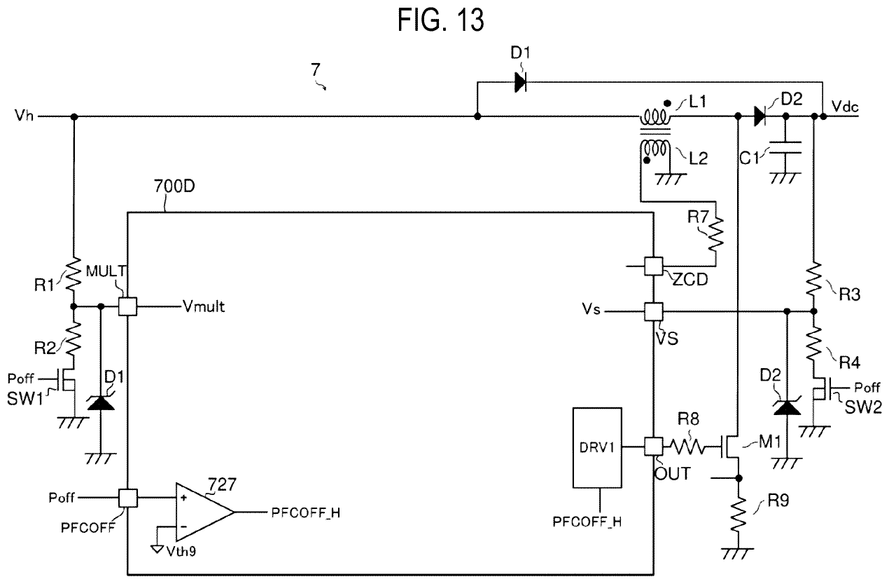

FIG. 13 is a diagram showing a configuration of a controller 700D according to a fourth embodiment of the present disclosure. In the present embodiment, a difference from the third embodiment is that the switches SW1 and SW2 are also provided outside the controller 700D. This eliminates the need for external terminals to connect the drains of the switches SW1 and SW2 in the controller 700D.

In the present embodiment, a control signal Poff is applied to gates of the switches SW1 and SW2. By setting the control signal Poff to a low level indicating a standby state, the switches SW1 and SW2 are turned off, thereby reducing power consumption. At this time, clamping by the diodes D1 and D2 can prevent a high voltage from being applied to the internal circuit by the voltage Vmult or the detection voltage Vs.

### Others

Various technical features disclosed in the present disclosure may be modified in various ways without departing from the spirit of the technical features, in addition to the above-described embodiments. In other words, the above-described embodiments should be considered to be exemplary and not limitative in all respects. The technical scope of the present disclosure should not be limited to the above-described embodiments but should be understood to include all modifications which fall within the meaning and scope equivalent to the claims.

### Supplementary Note

As described above, according to an aspect of the present disclosure, there is provided a power factor correction circuit (7) including a DC/DC converter. The power factor correction circuit (7) includes:
at least one selected from the group of first voltage dividing resistors (Rd1 and Rd2) and a first switch (SW1) connected to an application end of a first voltage (Vh) with a full-wave rectified waveform, and second voltage dividing resistors (Rd3 and Rd4) and a second switch (SW2) connected to an application end of an output voltage (Vdc) of the DC/DC converter; and
a controller (700A) configured to control the power factor correction circuit,
wherein an on-off operation of at least one selected from the group of the first switch and the second switch is controlled based on a control signal (Poff) which is input to the controller from outside to switch between a normal state and a standby state (first configuration).

The power factor correction circuit of the first configuration may include both the first voltage dividing resistors and the first switch, and the second voltage dividing resistors and the second switch (second configuration).

In the power factor correction circuit of the first or second configuration, the controller (700A) may include at least one selected from the group of a first external terminal (V H) configured to apply the first voltage and a second external terminal (VDC) configured to apply the output voltage, and at least one selected from the group of the first voltage dividing resistors and the first switch connected to the first external terminal, and the second voltage dividing resistors and the second switch connected to the second external terminal (third configuration).

In the power factor correction circuit of the third configuration, the controller (700B) may include at least one selected from the group of a third switch (SW3) and a first clamp circuit (D1) connected to a first node (Nd1) where a divided voltage is generated by the first voltage dividing resistors, and a fourth switch (SW4) and a second clamp circuit (D2) connected to a second node (Nd2) where a divided voltage is generated by the second voltage dividing resistors,
the controller may further include a delay circuit (728) configured to delay a signal based on the control signal to generate a first enable signal (PFCOFF_EN1) and a second enable signal (PFCOFF_EN2),
the first enable signal may be applied to at least one selected from the group of a control end of the first switch and a control end of the second switch, and
the second enable signal may be applied to at least one selected from the group of a control end of the third switch and a control end of the fourth switch (fourth configuration).

In the power factor correction circuit of the first or second configuration, at least one selected from the group of the first voltage dividing resistors (R1 and R2) and the second voltage dividing resistors (R3 and R4) may be provided outside the controller (700C), and
at least one selected from the group of the first switch and the second switch may be provided inside the controller (fifth configuration).

In the power factor correction circuit of the first or second configuration, at least one selected from the group of the first voltage dividing resistors (R1 and R2) and the second voltage dividing resistors (R3 and R4) may be provided outside the controller (700D), and
at least one selected from the group of the first switch (SW1) and the second switch (SW2) may be provided outside the controller (sixth configuration).

In the power factor correction circuit of the fifth or sixth configuration, the controller may include at least one selected from the group of a third external terminal (MULT) connected to a node (N1) where a divided voltage is generated by the first voltage dividing resistors, and a fourth external terminal (VS) connected to a node (N2) where a divided voltage is generated by the second voltage dividing resistors, and
at least one selected from the group of a third clamp circuit (D1) connected to the third external terminal and a fourth clamp circuit (D2) connected to the fourth external terminal may be provided outside the controller (seventh configuration).

An electronic device (1) according to an aspect of the present disclosure includes:
a rectifier circuit (5) configured to perform a full-wave rectification of an AC voltage (Vac); and
a power factor correction circuit (7) of any one of the first to seventh configurations configured to receive an output voltage (V h) of the rectifier circuit (eighth configuration).

According to an aspect of the present disclosure, there is provided a controller (700A) configured to control a power factor correction circuit (7) including a DC/DC converter. The controller (700A) includes:
at least one selected from the group of a first external terminal (VH) configured such that a first voltage (V h) with a full-wave rectified waveform is applied to the first external terminal (VH), and a second external terminal (VDC) configured such that an output voltage (Vdc) of the DC/DC converter is applied to the second external terminal (VDC);
at least one selected from the group of first voltage dividing resistors (Rd1 and Rd2) and a first switch (SW1) connected to the first external terminal, and second voltage dividing resistors (Rd3 and Rd4) and a second switch (SW2) connected to the second external terminal; and
a third external terminal (PFCOFF) configured such that a control signal (Poff) to switch between a normal state and a standby state is input to the third external terminal (PFCOFF),
wherein an on-off operation of at least one selected from the group of the first switch and the second switch is controlled based on the control signal (ninth configuration).

The controller of the ninth configuration may include both of the first voltage dividing resistors and the first switch, and the second voltage dividing resistors and the second switch (tenth configuration).

The controller of the ninth or tenth configuration may further include:
at least one selected from the group of a third switch (SW3) and a first clamp circuit (D1) connected to a first node (Nd1) where a divided voltage is generated by the first voltage dividing resistors, and a fourth switch (SW4) and a second clamp circuit (D2) connected to a second node (Nd2) where a divided voltage is generated by the second voltage dividing resistors; and
a delay circuit (728) configured to delay a signal based on the control signal to generate a first enable signal (PFCOFFEN_1) and a second enable signal (PFCOFFEN_2),
wherein the first enable signal may be applied to at least one selected from the group of a control end of the first switch and a control end of the second switch, and
wherein the second enable signal may be applied to at least one selected from the group of a control end of the third switch and a control end of the fourth switch (eleventh configuration).

The present disclosure can be used in AC/DC converters for various applications.

While certain embodiments have been described, these embodiments have been presented by way of example only and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A power factor correction circuit including a DC/DC converter, comprising:
at least one selected from the group of first voltage dividing resistors and a first switch connected to an application end of a first voltage with a full-wave rectified waveform, and second voltage dividing resistors and a second switch connected to an application end of an output voltage of the DC/DC converter; and
a controller configured to control the power factor correction circuit,
wherein an on-off operation of at least one selected from the group of the first switch and the second switch is controlled based on a control signal which is input to the controller from outside to switch between a normal state and a standby state.

2. The power factor correction circuit of claim 1, comprising both the first voltage dividing resistors and the first switch, and the second voltage dividing resistors and the second switch.

3. The power factor correction circuit of claim 1, wherein the controller includes at least one selected from the group of a first external terminal configured to apply the first voltage and a second external terminal configured to apply the output voltage, and at least one selected from the group of the first voltage dividing resistors and the first switch connected to the first external terminal, and the second voltage dividing resistors and the second switch connected to the second external terminal.

4. The power factor correction circuit of claim 3, wherein the controller includes at least one selected from the group of a third switch and a first clamp circuit connected to a first node where a divided voltage is generated by the first voltage dividing resistors, and a fourth switch and a second clamp circuit connected to a second node where a divided voltage is generated by the second voltage dividing resistors,
wherein the controller further includes a delay circuit configured to delay a signal based on the control signal to generate a first enable signal and a second enable signal,
wherein the first enable signal is applied to at least one selected from the group of a control end of the first switch and a control end of the second switch, and
wherein the second enable signal is applied to at least one selected from the group of a control end of the third switch and a control end of the fourth switch.

5. The power factor correction circuit of claim 1, wherein at least one selected from the group of the first voltage dividing resistors and the second voltage dividing resistors is provided outside the controller, and
wherein at least one selected from the group of the first switch and the second switch is provided inside the controller.

6. The power factor correction circuit of claim 1, wherein at least one selected from the group of the first voltage dividing resistors and the second voltage dividing resistors is provided outside the controller, and
wherein at least one selected from the group of the first switch and the second switch is provided outside the controller.

7. The power factor correction circuit of claim 5, wherein the controller includes at least one selected from the group of a third external terminal connected to a node where a divided voltage is generated by the first voltage dividing resistors, and a fourth external terminal connected to a node where a divided voltage is generated by the second voltage dividing resistors, and
wherein at least one selected from the group of a third clamp circuit connected to the third external terminal and a fourth clamp circuit connected to the fourth external terminal is provided outside the controller.

8. An electronic device, comprising:
a rectifier circuit configured to perform a full-wave rectification of an AC voltage; and
the power factor correction circuit of claim 1 configured to receive an output voltage of the rectifier circuit.

9. A controller configured to control a power factor correction circuit including a DC/DC converter, comprising:
at least one selected from the group of a first external terminal configured such that a first voltage with a full-wave rectified waveform is applied to the first external terminal and a second external terminal configured such that an output voltage of the DC/DC converter is applied to the second external terminal;
at least one selected from the group of first voltage dividing resistors and a first switch connected to the first external terminal, and second voltage dividing resistors and a second switch connected to the second external terminal; and
a third external terminal configured such that a control signal to switch between a normal state and a standby state is input to the third external terminal,
wherein an on-off operation of at least one selected from the group of the first switch and the second switch is controlled based on the control signal.

10. The controller of claim 9, comprising: both of the first voltage dividing resistors and the first switch, and the second voltage dividing resistors and the second switch.

11. The controller of claim 9, further comprising:
at least one selected from the group of a third switch and a first clamp circuit connected to a first node where a divided voltage is generated by the first voltage dividing resistors, and a fourth switch and a second clamp circuit connected to a second node where a divided voltage is generated by the second voltage dividing resistors; and
a delay circuit configured to delay a signal based on the control signal to generate a first enable signal and a second enable signal,
wherein the first enable signal is applied to at least one selected from the group of a control end of the first switch and a control end of the second switch, and
wherein the second enable signal is applied to at least one selected from the group of a control end of the third switch and a control end of the fourth switch.
